(19) United States
(12) Patent Application Publication
(10) Pub. No.: US 2004/0216129 A1
(43) Pub. Date: Oct. 28, 2004

(54) Object oriented telecommunications system controller

(76) Inventor: Gerard Hartnett, Limerick (IE)

Correspondence Address: JACOBSON, PRICE, HOLMAN & STERN, THE JENIFER BUILDING, 400 SEVENTH STREET, N.W., WASHINGTON, DC, 20004, US

(21) Appl. No.: 09/735,606

(22) Filed: Dec. 14, 2000

Related U.S. Application Data
(63) Continuation of application No. PCT/IE98/00107, filed on Dec. 15, 1998.

(30) Foreign Application Priority Data
Jun. 17, 1998 (IE) 980474
Aug. 31, 1998 (IE) S980713

(51) Int. Cl. G06F 9/44

(52) U.S. Cl. 719/315

(57) ABSTRACT

A telecommunications system controller framework (1) has application domain base objects (3) in base level (2), and a meta object (5) associated with each base object class. The meta level deals with containment, persistence data, and real resources. The meta objects (5) represent domain object classes. They also isolate the domain objects from services. The meta objects (5) have event channels for automatic notification to subscribers such as adapter objects in a services level.

### FIELD OF THE INVENTION

The invention relates to a framework for a telecommunication system controller to apply application or control logic to telecommunication services, and to a controller incorporating such a framework.

1. Prior Art Discussion

Heretofore, the approach to developing such controllers has been to link the software very closely to the hardware resources so that a fast response time is achieved for real time control. However, this approach does not allow for a significant level of modification of either the control logic or the resources which implement the telecommunication services.

2. Objects of the Invention

Therefore, it is an object of the invention to provide a controller which provides excellent flexibility for modifying the control logic and the resources in a manner which does not sacrifice controller speed performance.

### SUMMARY OF THE INVENTION

The invention provides a telecommunication controller comprising a control framework comprising:

an application domain level operative according to control logic domain objects; and

a meta level operative according to meta objects which represent the domain object classes, and provide an interface to isolate the domain objects from services associated with the controller.

Because the meta level represents the domain object classes, domain objects may be added, deleted, or modified without the need to directly notify other domain objects. The meta level effectively tracks the structure of the domain objects. Also, because the meta level interfaces with the telecommunication services, modifications to the services may be implemented transparently to the domain objects.

In one embodiment, the meta objects comprise event channels for automatic notification to subscribers.

Preferably, the meta objects are structured in a heirarchy of abstract classes for declaring action and attributes.

In one embodiment, the meta objects comprise means for invoking actions on domain objects and changes to attributes of domain objects.

In another embodiment, the controller comprises a key class naming objects in the domain level.

Preferably, the meta level defines containment of domain level objects and the domain level objects and the domain level comprises means for automatically notifying the meta level of containment modifications.

In another embodiment, the meta objects comprise means for interrogating a base object containment hierarchy to locate a required object in response to a request from a requesting object.

In a further embodiment the meta objects comprise means for performing persistence data operations transparently to the domain objects.

In another embodiment, the meta objects comprise means for updating a data backup controller for fault tolerance transparently to the domain objects.

Preferably the meta objects comprise means for verifying base object proposals to update real resource attributes. The meta objects may comprise means for publishing events on channels to notify adapter objects.

In one embodiment, the adapter objects are contained in a services level in the controller.

### DETAILED DESCRIPTION OF THE INVENTION

### BRIEF DESCRIPTION OF THE DRAWINGS

The invention will be more clearly understood from the following description of some embodiments thereof, given by way of example only with reference to the accompanying drawings in which:

FIG. 1 is a schematic representation of a control framework of a controller of the invention;

FIG. 2 is a diagram illustrating signal transfers for setting an attribute in a meta level;

FIG. 3 is a diagram illustrating signal transfers for creating a domain object;

FIG. 4 is a diagram illustrating attribute classes;

FIG. 5 is a signal transfer diagram for getting an attribute from the meta level;

FIG. 6 is a diagram illustrating action classes in the meta level;

FIG. 7 is a diagram illustrating invocation of an action from a meta object;

FIG. 8 is a signal transfer diagram for setting a key;

FIG. 9 is a diagram showing containment classes;

FIG. 10 is a diagram showing a simple example of domain level containment;

FIG. 11 is a diagram showing chained contained information classes for a domain level tree;

FIG. 12 is a signal transfer diagram showing declarations for shelf and slot domain objects;

FIG. 13 is a diagram showing signal transfers for setting an attribute;

FIG. 14 is a signal transfer diagram showing an operation for loading an object from persistent storage;

FIG. 15 is a diagram showing signal transfers for creating an object from persistent storage; and

FIG. 16 is a diagram showing setting of an attribute on a resource.

### DESCRIPTION OF THE EMBODIMENTS

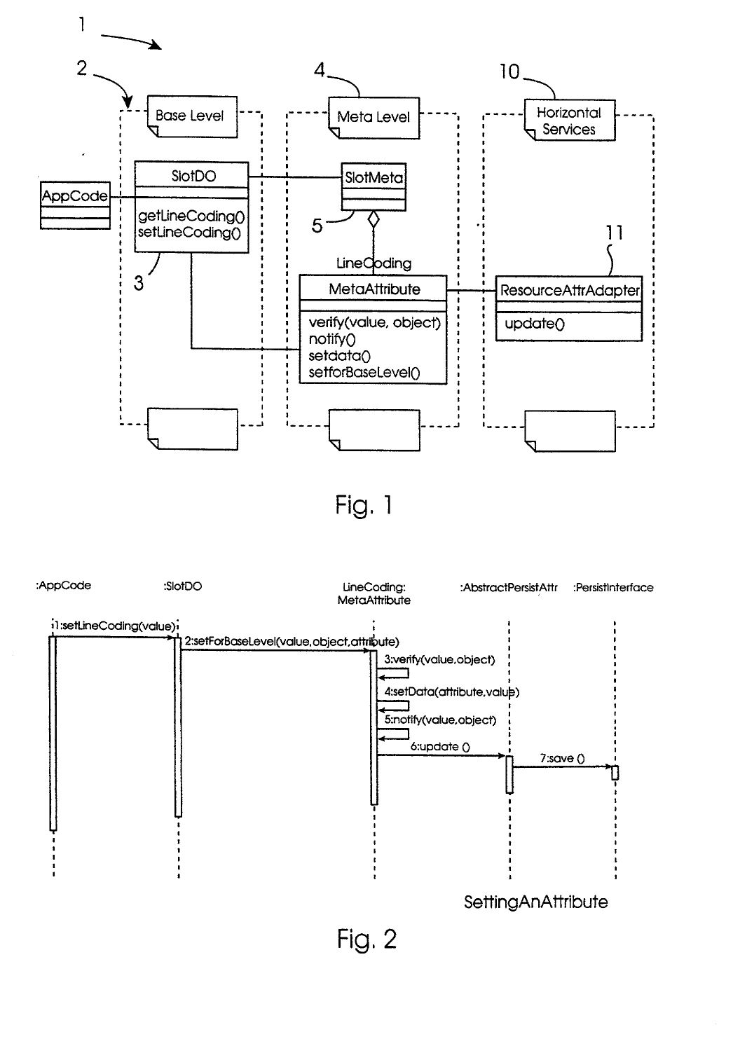

Referring to FIG. 1, the structure of a telecommunication controller 1 is illustrated. The controller 1 is in this embodiment for an asynchronous transfer mode (ATM system which performs conversion between ATM and time division multiplex TDM) formats. However, the structure may be used for any telecommunication controller which needs to perform in real time and which is programmed to control resources which provide the required services. The controller 1 comprises a base or domain level 2 and a meta level 4. The meta level 4 communicates with horizontal services 10 which may or may not be part of the controller 1. The base level 2 comprises domain objects (DOs) 3. The meta level 4 comprises meta objects 5. The horizontal level 10 comprises adapter objects 11 for resources, persistence, fault tolerance, and text.

The meta level 4 provides a representation of the structure of the base level object 3. The important information which the meta level provides includes:

information regarding attributes and actions for the domain object classes,

object containment configurations, and

which attributes are persistently stored, fault tolerant (replicated), and which are represented on real resources.

As an example of the role of the meta level, complex services such as downloading of the information in an object to hardware can be written using the meta level. The meta level allows telecommunication services to be added, deleted or modified without the need to re-program the base level, and likewise the base level code may be changed without the need to modify the services.

The structure of the controller 1 is best described with reference to illustrative examples. Referring to FIG. 2, a slot object 3 accesses a corresponding meta object 5, which in turn accesses a resource attribute adapter 11. Application code calls the setLineCoding method on the slotDO domain object. This function informs the meta level calling the setForBaseLevel on the meta attribute. The meta attribute verifies that the new value can indeed be changed. If, for example, the attribute represents a value on a line card, the real resource aspect of the meta object would have provided a verification strategy object to the meta attribute. In this case, the verification strategy object would try setting the attribute on that line card. If the verification failed for some reason, the meta attribute would stop and return an error status to the domain object. If the verification is positive (i.e. the line card has been updated) the meta attribute updates the raw data storage on the base level and then informs any subscribers it has for changes to the attribute by pushing an event into an event channel for the attribute. This notifies subscribers such as a persistent attribute adapter, which can store the new attribute value in the persistence storage layer PSL).

More generally, domain objects are described in an information model and examples include Card, Slot, and ATMInterface. The domain objects are generally implemented as standard C++ objects. They have get/set methods for attributes and any significant application logic is implemented in logic. These methods may use methods on other domain objects and they can create their contained objects and may contain states and state machines, and support alarm conditions. The domain objects invoke services on the meta level. However, the meta level also invokes services on the base level.

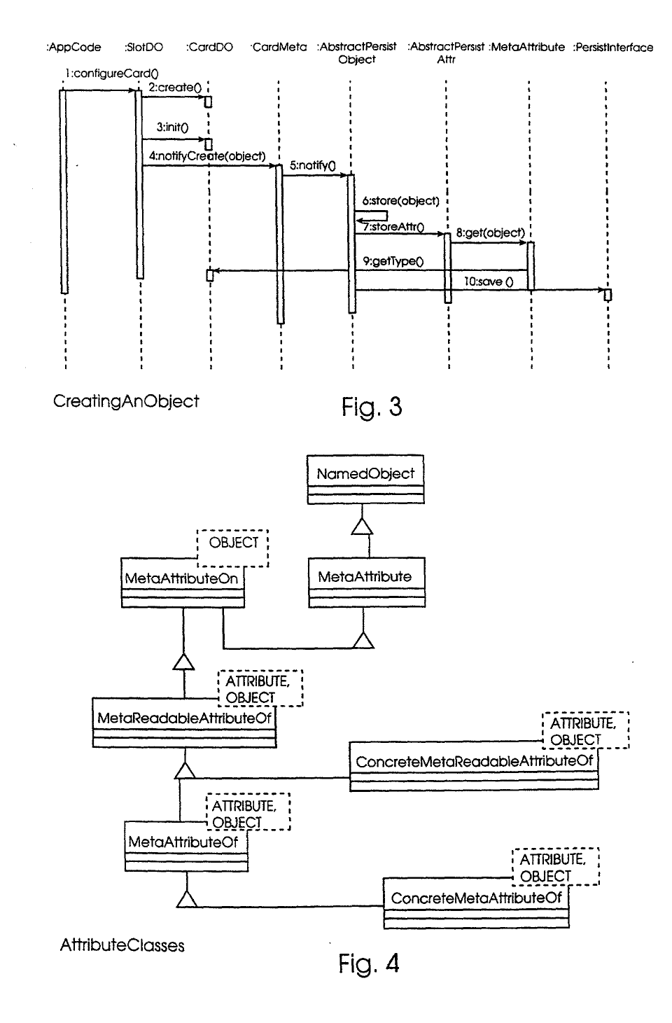

Referring now to FIG. 3, another example of the base level invoking the meta level is a parent object creating a contained object. The parent object creates the contained object and informs the meta level of this new object. This is done using the notifyCreate command which in turn causes the meta level to store the object and its attributes and to notify the persistence adapter. In general, there are three phases to creating an object as follows:

construction, in which the object is allocated,

initialisation in which the object is fully set up, and

notification in which the meta object is notified.

These three phases are generally controlled by the parent containing object.

Regarding the meta level, there is one meta object per class of domain objects. The meta objects are singletons and are containers for other objects which describe the domain object class. The meta objects contain attributes and actions and class “aspects” such as containment, persistence, agent interfacing, and fault tolerance information. The meta objects also contain event channels which are informed when an instance of a class is created. They are subscribers and so can learn of instance creation and deletion using these channels. FIG. 3 shows an example of this in which a meta object is notified of an object creation.

Attributes are contained in the meta objects S. Attributes can be get/set from the meta level as well as from the base level. Referring to FIG. 4, attribute classes are illustrated.

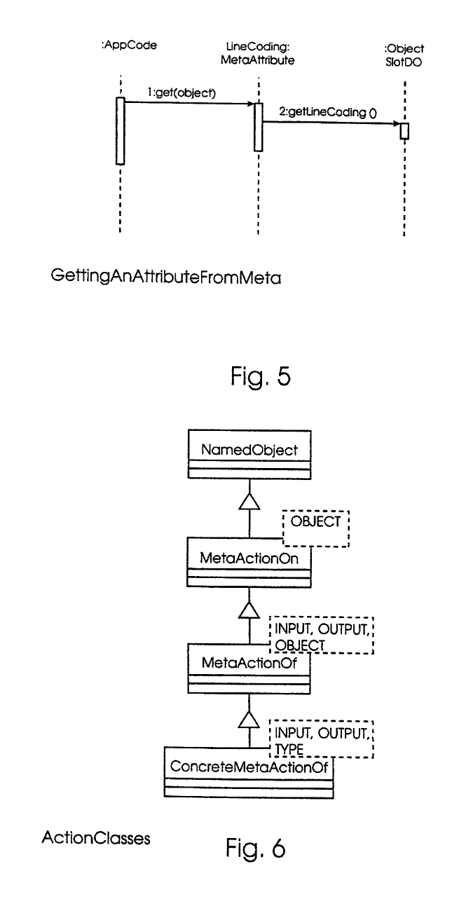

Referring to FIG. 5, getting an attribute from a meta object may be performed by application code signalling the meta object, in turn accessing the domain object.

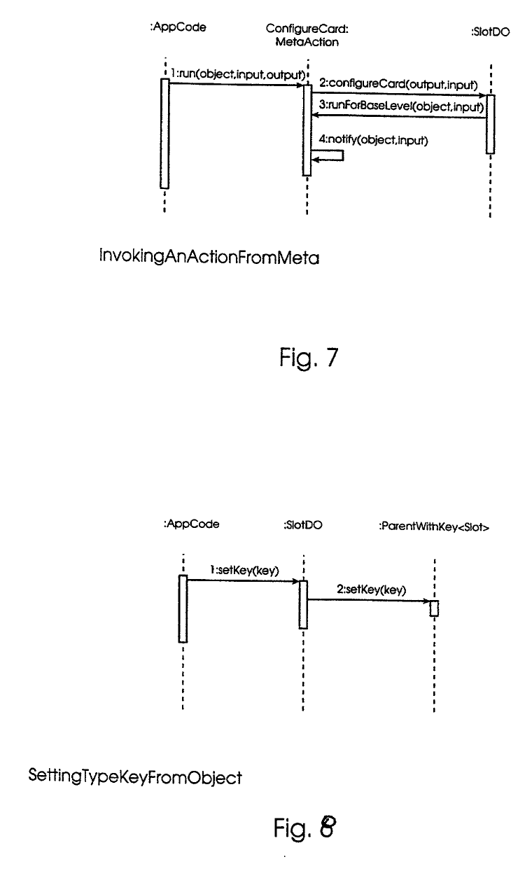

Referring to FIG. 6, meta actions are declared using a hierarchy of abstract classes to avoid using much code in header files. The concrete implementations of actions (typically just used in implementation of meta objects) take function pointers to the corresponding methods on the base level domain classes, as illustrated in FIG. 7. In general, meta actions support the domain concept of actions on a domain object. They are informed when the base level is running an “action”. They can also run the action from the meta level, for example for an action invocation from the client, an action request from the agent interface, or an action invoked by a command from the line card to the controller. Actions are contained in meta objects and contain meta information. The MetaAction run method takes an instance reference, which is used to call the base level function. It also takes a single const input reference and a single non-const output reference. If multiple input or output parameters are required then they are groomed into a single struct. By invoking actions through the meta layer, functionality generic to all actions is performed, such as replication, and providing debug information.

Referring now to FIG. 8, keys are simple classes which represent the information needed to uniquely identify an instance of a class. For example, a key for a shelf class may be as follows:

class ShelfKey
{
public:
unsigned shelfNum;
const unsigned & getIdent( ) const
{

return shelfNum;

}
void setIdent (const unsigned& newIdent)
{

shelfNum = newIdent;

}

};

In this example, the shelfNum in the key will uniquely identify a shelf instance. The getIdent and the setIdent functions are used in the ContainInfo code in the framework. These functions must not be virtual. The keys are made of inheritance chains. If an object of a class can be contained in objects of another class, then the key of that class will inherit from its containers key class. In the following example, Slot is contained in the shelf.

Class SlotKey : public ShelfKey
{
public:

unsigned slotNum;
const unsigned& getIdent ( ) const
{

return slotNum;

}
void setIdent (const unsigned& newIdent)
{

slotNum = newIdent;

}

};

The keys are stored in “closed to change” packages. A key can be used to find an instance of a domain object. This behaviour is supported from the meta level containment information, as illustrated in FIG. 8. The opposite scenario may also happen, in which an instance can set a key value. To do this, the instance sets the part of the key it understands. It needs its parent object to set the rest of the key, and so on up the tree.

In addition to the meta level providing information on domain object actions and information, it also provides containment information. The containment information of the meta level provides the following functionality:

finding a domain object using a stream representation of its identity.

creating a new domain object identified by a string representation of its identity,

creating an iterator for instances of the domain class, and

finding an object based on a key representation of its identity.

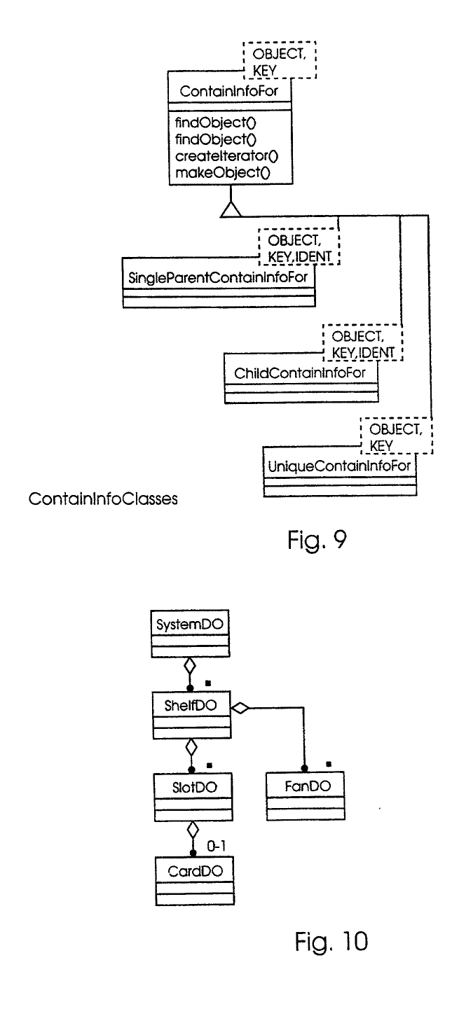

The “contain info” needs to know information such as the string representation of the class name, and this is obtained from the meta object. It also needs the containment information from its container classes to perform some of its functionality. Accordingly, instances of containment information objects tend to be chained together in a way that reflects the containment tree FIG. 9 illustrates ContainIofoClasses.

There are a number of different concrete containment information classes which implement the generic behaviour specified by the abstract ContainInfoFor.

Referring to FIG. 10, an example problem domain is illustrated in which there is a singleton representing the whole system, shelves are contained in the system, slots and fans are contained in a shelf, and cards are uniquely contained in a slot.

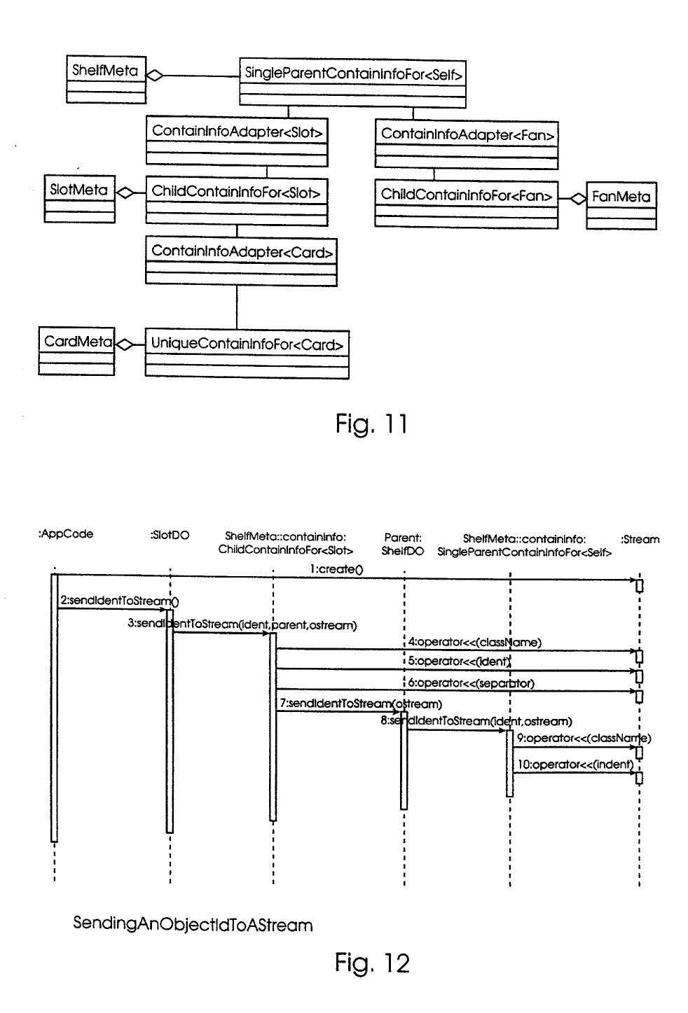

Referring to FIG. 11, ChainedContainInfo classes for the above problem domain containment tree are illustrated. The ShelfMeta contains the SingleParentContainInfoFor. It also contains ContainInfoAdapers for its two types of contained objects.

The meta level classes for containment need to use facilities implemented by the base level. These facilities are defined in the following two abstract classes:

ContainerOf—specifies the class is a container of another type of object. Means findObject, findFirstObject and findNextObject, all taking an identifier, must be implemented.

ContainerOfUnique—specifies the class is a container of a unique object. Means findObject taking no identifier must be implemented.

Referring to FIG. 12, the class declarations for the domain objects shelf and slot are illustrated. A combination of the parent and containment information is used to send the identification of an object instance to a stream.

Some of the attributes of the domain objects need to be persistently stored and this is handled by a meta object. The meta object contains an “AbstractPersistObject” adapter in the same way. The AbstractPersistObject provides interfaces whereby it can load all objects of a class from persistence and can subscribe to object creations and deletions. It also contains AbstractPersistAttr objects which are created for each attribute which is persistent.

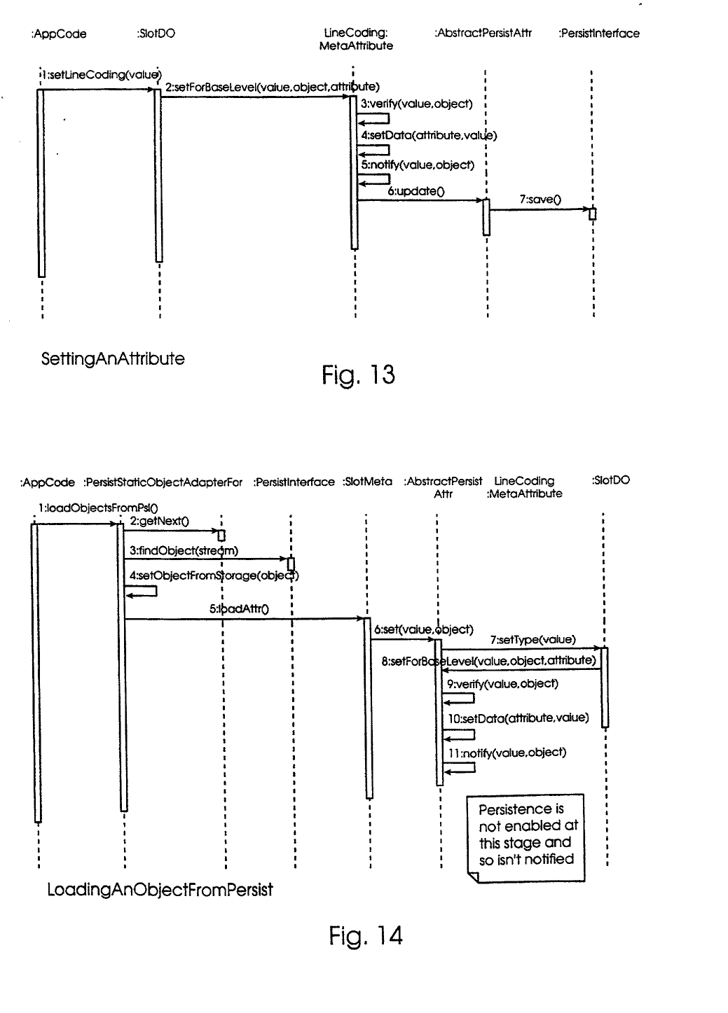

Referring to FIG. 13, the declarations for setting an attribute are illustrated. The AbstractPersistAttr subscribes to changes in the meta attribute and persistently stores the new values when changes do happen. A mechanism for loading an object from persistence storage is illustrated in FIG. 14.

In the example illustrated, the contain info is passed the whole stream. It finds the container and calls makeObject on. If the whole operation was successful a new object is returned. This is then initialised using the storage from the persistence layer finally the notifyCreate is called on the meta level.

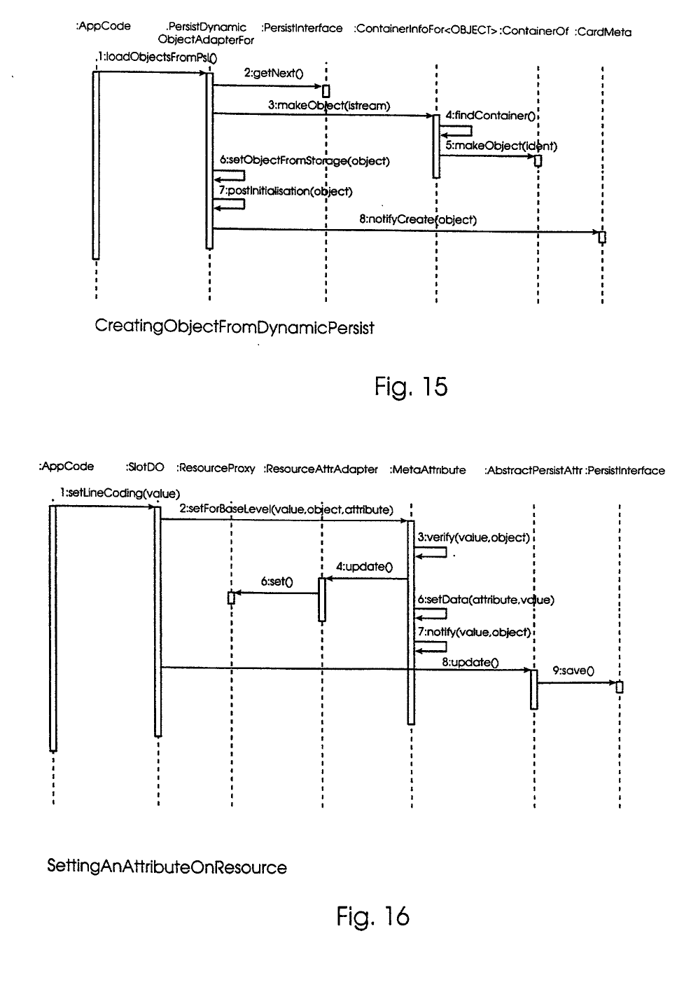

FIG. 15 shows creation of an object from persistent storage.

The meta level is also used for keeping track of and updating real resources. Typically, there are proxy objects for interacting with objects on the real resource. There are two scenarios:

(a) When the attribute is set the real resource must try to set the value first. This results in talking to a middleware proxy. If this works, the rest of the process of setting an attribute is run.

(b) If the real resource needs to be configured from the controller, in this case all of the real resource attributes need to be downloaded to the hardware. An action means calling a proxy function on the real resource, the proxy function can be called and return-checked in the base object function. If an attribute is read-only on the hardware and it can change autonomously, the get function in the domain object can call the proxy directly to get the value from the hardware.

A mechanism for setting an attribute on a real resource is illustrated in FIG. 16.

The meta level also provides an agent interface to the base objects for the agent sub-system. Some attributes may not be visible on the agent interface or they may be more restricted in their scope i.e. read-only instead of read/write.

Two other aspects of base objects and their representation as meta objects are polymorphism and text interfaces. Polymorphism is where there is a base class domain object from which derived classed are to be inherited the derived classes want to add new attributes and actions and so will have extra meta information as well as the information from the base class.

The text interface provides facilities for representing objects and attributes as text strings. It is used by the CLI software.

The meta-level architecture may also support domain object versioning.

It will appreciated that the invention allows application code and logic to be independent of the application level services. This means that changes to services can be made without affecting the general application logic, avoiding sweeping changes to the software system. These advantages have been achieved with a very simple and well defined interfaces between the base and the meta level.

New functionality can be added to the system without affecting the application code because most of the persistence, real resource interface, text interface, and auditing functionality can be written in terms of the meta level. Likewise, services may be modified without affecting the control logic.

The invention also achieves a high level of reuse and qualification of the system is simplified.

The invention is not limited to the embodiments described but may be varied in construction and detail within the scope of the claims.

1. A telecommunication controller comprising a control framework comprising:
an application domain level operative according to control logic domain objects; and
a meta level operative according to the meta objects which represent the domain object classes and provide an interface to isolate the domain objects from services associated with the controller.

2. A controller as claimed in claim 1, wherein the meta objects comprise event channels for automatic notification to subscribers.

3. A controller as claimed in any preceding claim, wherein the meta objects are structured in a hierarchy of abstract classes for declaring actions and attributes.

4. A controller as claimed in any preceding claim, wherein the meta objects comprise means for invoking actions on domain objects and changes to attributes of domain objects.

5. A controller as claimed in any preceding claim, wherein the controller comprises a key class naming objects in the domain level.

6. A controller as claimed in any preceding claim, wherein the meta level defines containment of domain level objects and the domain level comprises means for automatically notiying the meta level of containment modifications.

7. A controller as claimed in claim 6, wherein the meta objects comprise means for interrogating a base object containment hierarchy to locate a required object in response to a request from a requesting object.

8. A controller as claimed in any preceding claim, wherein the meta objects comprise means for performing persistence data operations transparently to the domain objects.

9. A controller as claimed in any preceding claim, wherein the meta objects comprise means for updating a data backup controller for fault tolerance transparently to the domain objects.

10. A controller as claimed in any preceding claim, wherein the meta objects comprise means for verifying base object proposals to update real resource attributes.

11. A controller as claimed in claims 8, 9, or 10, wherein the meta objects comprise means for publishing events on channels to notify adapter objects.

12. A controller as claimed in claim 11, wherein the adapter objects are contained in a services level in the controller.
